(19) United States
(12) Patent Application Publication
(10) Pub. No.: US 2020/0364709 A1
(43) Pub. Date: Nov. 19, 2020

(54) Networked Computer System for Multi-Party Payment Distribution and Pricing

(71) Applicant: David Newman, Evanston, IL (US)

(72) Inventor: David L. Newman, Evanston, IL (US)

(21) Appl. No.: 16/411,389

(22) Filed: May 14, 2019

(51) Int. Cl. G06Q 20/38; H04L 9/06; G06Q 20/40; H04L 9/08

(52) U.S. Cl. CPC G06Q 20/3829; H04L 9/0637; G06Q 50/14; H04L 9/0822; G06Q 20/40975

(57) ABSTRACT

The present invention provides a system comprising a memory, a blockchain stored within the memory, the blockchain comprising a first block comprising a patent number and patent owner information. The blockchain also comprising a second block including first licensee information and a standard contract including a license grant and a payment module configured to generate proportional payments for a custodian identified in the blockchain by calculating the proportional payments based on rates provided in the second block, the proportional payments distributed among more than one custodian and the first and second block combined into the blockchain.

This application claims priority from Provisional application No. 62/672,111, filed May 16, 2018.

The present invention pertains to a networked computer system for providing a contract and multi-party payment distribution and pricing system that makes use of distributed computing such as Distributed Ledger Technology (DLT).

### BACKGROUND

Spreadsheets are known for keeping track of numerical data from groups of contracts. However, individual spreadsheets are not linked via computer networks nor via DLT. Smart contracts are known, but not for patent licenses. The present invention provides a new combination of these technologies to form a digitized patent license contract that is shared via a DLT.

### SUMMARY

The present invention comprises a system comprising a memory, a blockchain stored within the memory, the blockchain comprising a first block comprising a patent number and patent owner address; and a second block including a first licensee address and a standard contract including a license grant. The invention provides a payment module configured to generate proportional payments for a custodian identified in the blockchain by calculating the proportional payments based on rates provided in the second block, the proportional payments distributed among more than one custodian and the first and second block combined into the blockchain.

In an embodiment, the invention provides for the custodian to control or own an asset contributed to the blockchain. In an embodiment, the invention provides for the asset comprising one of a comparable licensing data, valuation data, proposed royalty rate, Fair Reasonable and Non-Discriminatory (FRAND) rate, patent license grant, IP assignment, IP license, IP covenant not to sue. In an embodiment, the invention provides for the blockchain to provide evidence of the FRAND rate. In an embodiment, the invention provides for the blockchain comprising a proportional payment and determination when a contract has been executed.

In a further embodiment, the invention provides for a method of securely storing data across a network in a multi-dimensional distributed database, said method comprising the steps of generating a blockchain comprising linked data blocks, said blockchain being configured to propagate one or more branching blockchains, wherein any existing branching blockchain is configured to propagate one or more additional branching blockchains, wherein each of said branching blockchains has a fork block from which said one or more branching blockchains can grow in multiple directions thereby forming a multi-dimensional database slidechain, wherein said growth occurs by adding new data blocks awarded each time a participating node in the network propagates an acceptable block with corresponding block hash, said fork block comprising a customizable set of licensing protocols that define, for each block in said branching blockchain at least how block data is stored, how block validity is verified, how valid chain consensus is achieved, and criteria for generating a new block, wherein a copy of said slidechain is distributed to every node in the network, and said one or more new blocks are propagated when a node in the network provides a valid response to an payment algorithm.

In an embodiment, the invention provides for computing a proportional share of the root payment protocol, storing data as a fork block payload to be included as part of the fork block, wherein said fork block comprises a custodian address and computing a payment proportion and distributing the payment portion from a contract protocol.

In a further embodiment, the invention provides for the steps of creating a slide chain rule set describing computer readable instructions for interpreting and/or parsing data stored in data blocks; and storing said slide chain rule set as said root block payload wherein supplemental patent license contracts are executable on the slide chain. In an embodiment, the invention provides for the steps of creating a slide chain rule set describing computer readable instructions for interpreting and/or parsing data stored in data blocks; and storing said slide chain rule set as said fork block payload including supplemental licensees.

In an embodiment, the invention provides for the steps of creating a slide chain rule set describing computer readable instructions for verifying the validity of data blocks; and storing said slide chain rule set as said root block payload in order to distribute proportional payments to custodians including asset owners and valuators. In an embodiment, the invention provides for the steps of creating a slide chain rule set describing computer readable instructions for verifying the validity of data blocks; and storing said slide chain rule set as said fork block payload including transparent rate data.

In another embodiment, the invention provides for a computer system configured to communicate with a distributed blockchain computer system that includes multiple computing nodes, each computing node configured to store a copy, or a portion thereof, of a blockchain of the distributed blockchain computer system, the computer system comprising: a transceiver configured to receive a match message from another computer system that matches data transaction requests, the match message including match data for a match between a first data transaction request that is associated with a first identifier and a second data transaction request that is associated with a second identifier; a storage system configured to store a data structure for a plurality of accounts, each one of the plurality of accounts including at least a private key and a public key, the plurality of accounts including an intermediary account, where the first and second identifiers are associated, respectively, with first and second accounts of the plurality of accounts.

In an embodiment, the invention provides for a processing system that includes at least one hardware processor, the processing system configured to, in response to reception of the match message, (a) generate a first blockchain transaction that includes the match data for the match between the first data transaction request and the second data transaction request; (b) transmit the first blockchain transaction to the distributed blockchain computer system for storage into the blockchain

In a further embodiment, the invention provides for generating at least one further blockchain transaction that includes information for a first transaction from the first identifier to an intermediary identifier that is associated with the intermediary account and information for a second transaction from the intermediary identifier to the second identifier; generate a second blockchain transaction and include a programmatic structure into the second blockchain transaction that is configured to be executed by the distributed blockchain computer system, the programmatic structure including a condition that, upon satisfaction thereof, is configured to trigger the generation of a third blockchain transaction that is submitted to the blockchain, wherein the condition is payment of a portion of a payment to a custodian as a result of the conclusion the blockchain transactions; and transmit the at least one further blockchain transaction including payment data to the distributed blockchain computer system for storage into the blockchain.

In an embodiment, the invention provides for the custodian including an asset owner and a valuator, wherein the custodian includes the information for the first transaction from the first identifier to the intermediary identifier and the valuator includes information for the second transaction from the intermediary identifier to the second identifier. In an embodiment, the invention provides for the processing system to be further configured to sign, with a private key from a trusted oracle account, an event that is used to satisfy the condition of the programmatic structure. In an embodiment, the invention provides for satisfaction of the a condition occurs if and only if the event has been signed by the private key of the trusted oracle account allowing for viewing of confidential blockchain data including contract terms.

In an embodiment, the invention provides for the payment transaction to be structured to be from an identifier associated with one of the plurality of accounts that is associated with the computer system that matches data transaction requests to an identifier of an account associated with the computer system. In an embodiment, the invention provides for a license contract on a blockchain comprising the steps of broadcasting a smart contract of a blockchain to potential licensees, inserting names and addresses of the potential licensees into the blockchain, soliciting a valuation from an appraiser, finalizing license contract terms by potential licensee, reviewing previous licensing terms on the blockchain by the potential licensee, executing the license contract, notifying custodians of payment amounts and distributing payments to custodians and patentee.

### BRIEF DESCRIPTION OF THE FIGURES

The figures of this application provide a specific depiction of some of the preferred embodiments of the present invention, yet do not depict all of the embodiments to which one of ordinary skill in the art may understand from review of this application.

FIG. 1 is a schematic view of the Blockchain PLC invention of the present invention;

FIG. 2 is a flow diagram of the steps of an embodiment of the present invention;

FIG. 3 is a flow diagram depicting another embodiment of the present invention;

FIG. 4 is a flow diagram of the steps of a further embodiment of the present invention; and

FIG. 5 is a schematic diagram of node computers and wide area network of the present invention.

### DETAILED DESCRIPTION

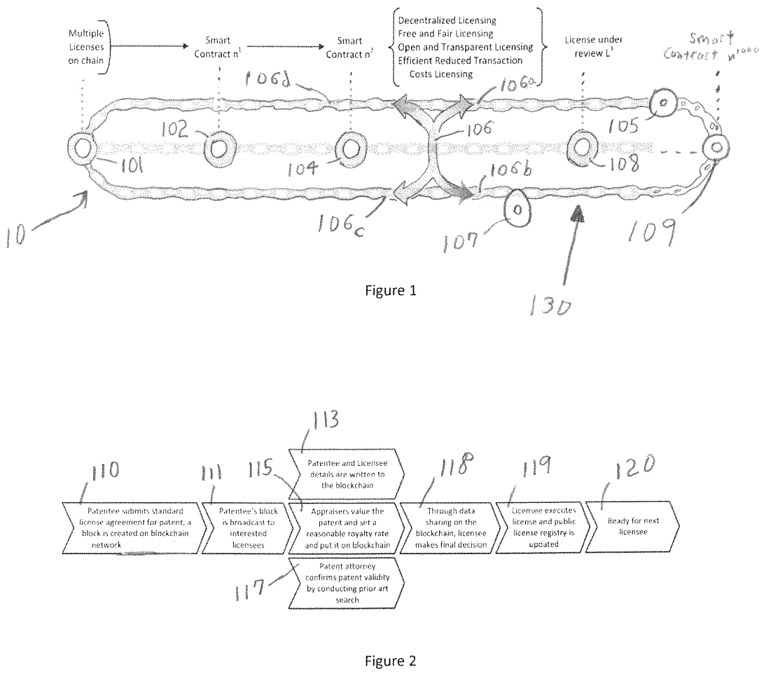

FIGS. 1-5 depict a patent license contract (PLC) invention that provides smart contracts that include protocol for making payments to multiple parties in a transaction blockchain once a final license contract is complete. Due to the decentralization, the use of blockchain PLCs lowers transaction costs and greatly accelerates the time to process such PLCs (as compared to current manual processing and negotiation of current patent license agreements occurring bilaterally). Under this PLC blockchain system, once a patent owner provides or approves a suitable standard license agreement, thousands of licensing transactions may be consummated simultaneously along the blockchain. Such automated PLC smart contracts can establish an Intellectual Property (IP) marketplace via blockchain transactions.

As shown in FIG. 1, a blockchain 100 will have multiple license agreements executed n¹ 102 to n¹⁰⁰⁰ 109. For example, a potential licensee L³ 108 may be the third technology implementer in the chain 100 following licensee Alpha, that executed smart contract n¹ 101 and licensee Beta who executed smart contract n² 104. Third licensee L³ 108 may review the previous smart contracts 101 n¹, n² and each of the terms of such agreements to determine a fair rate and non-discriminatory terms.

For each PLC 101, each party that provides needed information (verification of validity or pricing) or an asset (patent rights) needed to complete the final contract (Custodian), receives a portion of the overall payment required by the final contract by using Custodian information included in the ledger/blockchain 100 in which the transaction is recorded. Such multiple party payment incentivizes Custodians to report final rates and terms using the blockchain 100 that connects similar transactions and contractually obligates payments to be made to Custodians. Where a Custodian is a valuator and provides comparables data for a license contract, payment of part of the royalty to the blockchain 100 of valuators is provided to the Custodian. In an alternate embodiment, Pay it forward protocol allows payments to be made to the next inventor of similar technology by supplementing a new patent number to the blockchain 100 where similar technology is being licensed. The system provides a custodian with control or ownership of an asset to be contributed to the blockchain 100. The system has smart contracts 101 that provide a proportional payment and determination when a contract has been executed.

As shown in FIG. 2, at step 110 the process starts with a patentee posting a standard license agreement to a blockchain 100, such as Blockchain Patent Sharing Alliance or 0 Chain.

The PLC 101 is established by converting the standard patent license agreement to a smart contract 101 that has automated steps such as royalty distribution and quarterly license reporting compliance. At step 111, the smart contract of the blockchain 100 is broadcast to potential licensees. For example, if the PLC 101 is for a standard essential patent for G5 (Fifth Generation) transmission technology for a mobile phone, a list of potential licensees may be received from the G5 standards organization (e.g. IEEE) and solicitations may be sent to such G5 standards implementers for the PLC blockchain 100. Once some interest is shown in the PLC offering, the names and addresses of the interested parties are inserted into the blockchain (step 113). The smart contract may then solicit an appraiser (accountant, damage expert, economist) from a pre-established list to conduct a reasonable royalty or FRAND rate determination 115. Also at step 117, a patent attorney from a pre-established list of subject matter experts is solicited to conduct a prior art search in order to confirm the validity of the patent underlying the PLC. The smart contract may specify a flat rate by which the appraiser and patent attorney will be paid for their evaluation and such payments shall be made out of the royalty payments or license fee payments made by licensees at later stages of completion of the PLC smart contract. (See also FIG. 4 below).

After the standards implementer reviews the terms of the PLC and negotiates additional terms (such as cross-licensing price offsets), as well as previous licensing data from the patentee posted to the blockchain 100, the negotiation between licensee n1 and patentee are concluded 118. At step 119 the PLC is executed and all interested parties are notified and can view the blockchain 100 to review the licensing terms. At step 120 the process begins again with a new potential licensee viewing the blockchain in order to examine licensing terms of previously executed licenses.

The PLC 101 provides a method of securely storing data across a network in a multi-dimensional distributed database. In an alternate embodiment, a blockchain 100 has linked data blocks, said blockchain being configured to propagate one or more branching blockchains 106 for multiple PLCs 105, 107 (FIG. 1), having any existing branching blockchain 106a is configured to propagate one or more additional branching blockchains 106b, having each of said branching blockchains has a fork block from which said one or more branching blockchains 106 may grow in multiple directions thereby forming a multi-dimensional database known as a slidechain 130 (for increased processing speeds), having said growth occurs by adding new data blocks 105, 107 awarded each time a participating node in the network propagates an acceptable block with corresponding block hash, said fork block comprising a customizable set of protocols that define, for each block in said branching blockchain 106 at least how block data is stored and interpreted, how block validity is verified, how valid blockchain consensus is achieved, and criteria for generating a new block, having a copy of said slidechain 130 is distributed to every node in the network.

One or more new blocks 107, 105 are propagated when a node in the network provides a valid response to an algorithm along with proof of work for the valid response, having data stored in a block cannot be modified without invalidating all subsequent blocks, having generating said blockchain or branching blockchain 106c, d for multiple PLCs that includes: creating a root block payload 106c to be included as part of a root block, having a root block comprises the root block payload having a contract having multiple custodian obligations and user obligations, a root timestamp, a root cryptographic nonce, a root payment protocol; computing a proportional share of the root payment protocol; storing data as a fork block payload to be included as part of the fork block 106, having said fork block comprises a custodian address; computing a payment proportion and distributing the payment portion from a contract protocol.

### Detailed Steps of PLC Execution

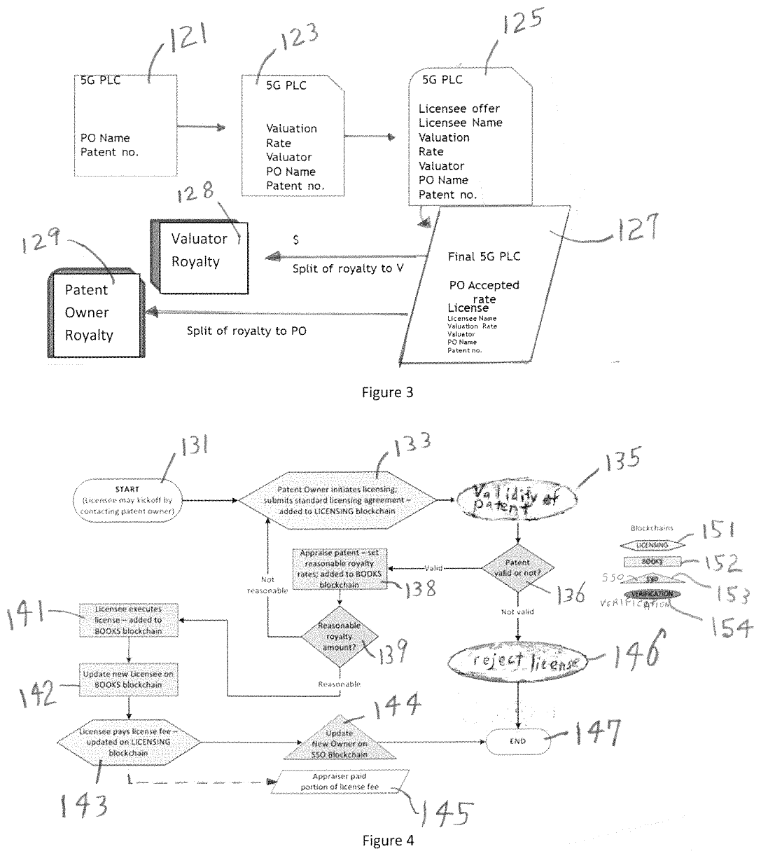

Turning to FIG. 3, the blockchain of the PLC lists present day inventor and/or patent owner (PO) 121 who is first to register a patent. Additional data is added to the PLC node, such as valuator name and valuation rate 123. The smart contract then implements code to find potential infringers by using a forward citation algorithm based on computer database, such as Google Patent 125. The blockchain 100 may also include Standard essential patents (SEP) identified by standard setting organizations (550s). The blockchain requires a recipient/patentee to disclose royalty rates offered in previous similar license agreements.

Multiple patent license contracts (PLC) are circulated that include the patent number, standard number and a proposed FRAND royalty rate 123 (see FIG. 3). The PLC is received by implementer/licensee who takes the mean of all received royalty rates to arrive at a FRAND rate and pays royalty. Each blockchain 100 for each SEP, builds the blockchain and royalties paid to all licensors are in the blockchain 100 for those patent owners who have a related patent. If there are any conflicts, the parties are contractually bound to use arbitration system (like UDRP system) for an arbitrator to examine the blockchain of rates to determine a FRAND rate.

Turning to FIG. 4, the process starts with a licensee (potential infringer) contacting the patent owner 131. A patentee will provide the standard license agreement (smart contract) that will make up the Licensing Blockchain 151 and the particular data from the transaction that will be disclosed to the corresponding Standard Setting Organization (SSO) for the SSO Blockchain 133. The patentee cannot alter data from the Books 152 or Verification Blockchains 154 and has read only access.

In cases where the smart contract process calls for the validity of the patent(s) underlying the PLC to be verified 135, a patent attorney after conducting a prior art search and confirming the validity of the patent(s) shall update the Verification Blockchain 154 to show validity 136. In cases where validity cannot be confirmed, only the patentee will have access to the Verification Blockchain 154, so that the patentee may withdraw 147, the negatively affected patent(s) from the Licensing Blockchain 151. In cases where the patent(s) validity has been confirmed 138, the patentee can authorize the patent attorney to re-designate read only access to the Verification Blockchain 154 for Appraisers, Licensees, Future Licensees and Speculators, so they can affirm that the underlying patent(s) is valid. In some cases a patent attorney may also be called upon to make an essentiality determination to confirm that an underlying asset is a Standard Essential Patent (SEP). In such a case, the patent attorney shall be provided create and update access to the SSO Blockchain 153.

An appraiser/valuator may create data fields and update data for the Books Blockchain 152 where due diligence data is collected to analyze and determine the value of the patent(s). In most cases, the appraiser will not need access to the Licensing Blockchain 151, unless its analysis is based on a factor (such as a Georgia Pacific factor) that requires access to the terms of the underlying license agreement. Any data relied on by the appraiser to establish a comparables rate should be included in the Books Blockchain 152, so that licensees and future licensees may access such data throughout the life of the blockchain in order to make a determination of a fair and reasonable license rate 139. In some cases, an appraiser will be required to provide an appraisal prior to execution of each PLC on the blockchain. In other circumstances an appraisal may only be needed periodically (e.g. annually).

A licensee may be allowed access to update the Books Blockchain 152 to provide its address and banking/account data 142. When royalty payments are made by licensee (e.g. quarterly) a record of the amount of the payment may be entered in the Books Blockchain 152, unless the patentee has indicated that information should be maintained confidentially—in which case the future licensees and speculators should be denied access to the Books Blockchain 152.

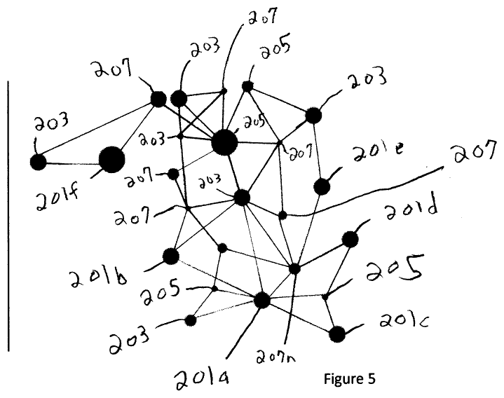

Turning to FIG. 5, the system provides for a decentralized consensus PLC system for tracking transferable digital objects, the system comprising: 1) a plurality of node computers 201a-f, each node computer 201 in said plurality of node computers 201a-f including a processing unit, some amount of memory accessed by said processing unit, and a network interface operatively coupled to said processing unit and a wide area network 203 connecting said plurality of node computers 201a-f; 2) each node computer 201 within said plurality of node computers 201a-f including a consensus system software application running on said processing unit of said node computer 201; and 3) said consensus system software application adapted to: A) load an initial ledger containing a first set of digital objects; B) connect to peer nodes 205 over said wide area network 203; C) download smart contract data from connected peer nodes 205, said smart contract data including one or more data blockchains 10 (FIG. 1), each data blockchain 10 within said one or more data blockchains 10 including a set of data blocks, each data block within said set of data blocks including a set of transactions and signed by one or more block signers 207 within a set of block signers 207n; D) included in the blockchain 10 a set of consensus rules to make proportional payments to the block signers who have completed the blockchain according to a set of protocol rules; E) where said block signers 207 include more than one block signer 207n, having said consensus data blockchain 10 includes a set of valid transactions and a set of valid data blocks; F) pass said set of valid transactions and said set of valid data blocks to one or more connected peers 205 over said wide area network 203, having said set of valid transactions and said set of valid data blocks are verified to follow said set of protocol rules; and G) maintain a current ledger, said current ledger built from said initial ledger, said valid transactions, said valid data blocks and said signer payments.

The present PLC provides a decentralized consensus PLC system having: 1) each digital object within said first set of digital objects includes a smart contract for transferring an asset owned by at least one block signer; and 2) said consensus system software application is further adapted to: A) determine an approval for each said contract; B) calculate the proportional payment based on said approval; C) determine a set of block signers to receive the payment, a summed approval and an approval height for each block signer candidate within said set of block signer candidates based said balance and said collection of votes; D) from said set of block signer candidates. The decentralized consensus PLC system having said consensus system software application is further adapted to reject a first block within said set of data blocks when said first block fails to follow said set of protocol rules.

The decentralized consensus PLC system has: 1) more than one data blockchain 10 (FIG. 1) includes a first fork chain 106a and a second fork chain 106b; and 2) the consensus system software application is further adapted to: A) identify a set of most recent blocks 105 on said first fork chain 106a; B) determine a first contract 105 from said first fork chain 106a; C) determine a second contract 107 from said second fork chain 106b; D) derive a pricing parameter for said first and second fork chain 106a,b from said first and second contract 105, 107.

The PLC in an alternate embodiment further comprises a means for generating a first key secret by combining multiple portions of the first key secret in a key secret exchange, having confidential portions of the blockchain may only be disclosed when the first key secret is used to access the confidential portions.

The PLC provides a system for tokenizing and pricing patent licenses and distributing tokens or payments to all participants as follows (see FIG. 3):
1. Patent Owner (POs) that reside in particular technology category are identified and Patent License Contract (PLC) 121 established with patent no. PO name, address, technology category/standard no. and approximate annual revenues;
2. Valuator sees new PLC posted on website and following certified valuation protocol sets valuation for PLC and Valuator added to PLC 123;
3. Technology Implementer sees new PLC on website or receives notice from website of actionable PLC and sets license offer based on Valuator and TI are added to PLC 125;
4. Actionable PLC sent to PO based on standard license agreement. PO has 5 days to send counterproposal with modified terms and rate; and
5. If TI accepts PLC 127 the portion of all royalties (and up front payment) is split between Valuator 128 and PO 129 according to formula (see look-up table 1) or tokens and PLC blockchain starts where next TI sees blockchain of PLCs.

Once a PLC is finalized, a trading price is set for each PLC token based on the royalty rate. PLC traders may trade PLC tokens and set new pricing for PLCs and all transactions are recorded in the blockchain. PLCs establish transparent pricing and PO obtains fair compensation based on PLC rate, TI obtains a Fair Reasonable and Non-Discriminatory (FRAND) license and a Valuator is compensated by getting a small portion of PLC up-front payment. The PLC avoids expensive litigation and provides centralized marketplace for monetizing technology and market for third parties to trade contracts based on technology category.

Use of PLC provides FRAND compliant process and blockchain of PLCs insures that all TI can obtain FRAND licenses. The PLC may imbed within the blockchain recitation and smart contracts for other assets such as sale of equipment via a broker and commodities including carbon emissions or solar credits.

As an example, FIG. 3 depicts a use for ETSI 5G standard and list all SEP Owner's who have provided FRAND commitment. The PLC provides a system comprising a memory, a blockchain stored within the memory, the blockchain comprising a first 5G block 121 comprising a patent number and patent owner address; and a second 5G block 125 including a first licensee address and a standard contract including a license grant; and a payment module 129 configured to generate proportional payments for a custodian identified in the blockchain by calculating the proportional payments based on rates provided in the second block. The proportional payments are distributed among the custodians or owners of IP 129 or valuators 128. The system provides comparable licensing data, valuation data, proposed royalty rate, Fair Reasonable and Non-Discriminatory (FRAND) rate, patent license grant, IP assignment, IP license, IP covenant not to sue. The system has blockchain that provides evidence of the FRAND rate 123. If there are more than one custodian, the first and second block are combined into the blockchain 121.

As shown in Table 1, there is a sample look-up table for determining the proportional amount of the payment that custodians obtain for providing assets to the blockchain transaction. It is to be understood that the blockchain can continue for as long as there are parties that desire to obtain the asset being offered by that blockchain. According to the algorithm of the look-up table, upon execution of the contract provided by the blockchain by a 100^{th} party, a proportional payment of 1/100 (10%) of the royalty rate shall be paid to the custodians. Likewise, upon execution of the contract provided by the blockchain by a 200^{th} party, a proportional payment of 1/200 (10%) of the royalty rate shall be paid to the custodians. In such an example, each transaction 1-200 shall be made part of the ledger and recorded in the entire blockchain.

In the example provided by Table 1, the first custodian C1 is a patent owner who obtains 90% of the total royalty due for each individual block/transaction and each custodian thereafter, C2-Cn are valuators that have provided data that supports a reasonable royalty analysis or FRAND rate analysis.

TABLE 1
Look-up Table

| | | Unit |
|---|---|---|
| | Proportional | Royalty |
| Custodian | Share | Rate |
| C1 | 90% | 1$ |
| C2 | 10% | 1$ |
| C3 | ⅓ (10%) | 1$ |
| C4 | ¼ (10%) | 1$ |
| C5 | ⅕ (10)% | 1$ |
| C6 | ⅙ (10%) | 1$ |
| Cn | 1/n (10%) | 1$ |

In an alternate embodiment of the PLC the valuator or custodians may receive tokens for the contribution of their assets. In such a system, the blockchain is tokenized and each block has a designated number of tokens assigned or each underlying transaction is valued and is assigned a particular number of tokens. The tokens are paid back to the custodians based on a smart contract provided by the blockchain. As well, third parties may trade the tokens in order to speculate on the increasing or decreasing value of the technology being licensed in the underlying blockchain transaction. In place of a valuator, in an alternate embodiment there may be an oracle to provide verification of the pricing of the underlying blockchain transaction. The tokenized patent license contracts may be traded on an ATS such as T-zero.

In another embodiment an Ethereum system may be used and the custodians are paid in ether. In an embodiment, a consensus mechanism such as delegated proof of stake is provided in the blockchain to penalize any transactions that are not carried out at fair or FRAND rates. In an embodiment, portions of the blockchain are de-identified, such as the licensor name or patent owner name in order to protect the patent owner's ability to engage in non-FRAND transactions outside of the blockchain (with non-standards participants). By using cryptographic means of protecting and de-identifying portions of the data in the blockchain, such confidential information may be more secure than having the data on a centralized node at the patent owner's headquarters that can be hacked more easily than the encrypted blockchain.

The flow diagram of FIG. 4 depicts a combination of four blockchains: Licensing 151, Books 152, Standard Setting Organization (SSO) 153 and Verification 154. By having separate blockchain categories 151-4, particular information may be segregated for distribution to preselected parties according to an access control look-up table, such as Table 2.

TABLE 2
Access Control Look-up Table

| | Access Control | | | |
|---|---|---|---|---|
| | Licensing | SSO | Books | Verification |
| Organization | Blockchain | Blockchain | Blockchain | Blockchain |
| Patentee | Create, | Create, | Read Only | Read Only |
| | Update | Update | | |
| Patent Attorney | Update* | Read Only | None | Update |
| Appraisers | None | Read Only | Create, | None |
| | | | Update | |
| Licensee | Read Only | Read Only | Update | None |
| Future Licensee | Read Only | Read Only | Read Only | None |
| Speculater | Read Only | Read Only | Read Only | None |

*Confidential-only patent owner notifed of rejection of patent

### Access Control

Each level of blockchain has different access control protocol in order to control confidentiality and security designations by organization/party type. By combining with a hashing function, added security may be incorporated with these blockchains. The Access Control chart below correlates to the Flow Diagram (FIG. 4). In an embodiment, each of the four blockchains may be combined: Licensing 151, Books 152, Standard Setting Organization (SSO) 153, and Verification 154 (FIG. 4). Importantly, only the patent owner will be notified (verbally) if there is a negative finding (e.g. invalidity or non-patentable subject matter) with respect to the validity of the patent(s) that is the subject of the PLC. Such negative information would be highly sensitive to the patent owner and should not be included in the blockchain where other third parties or potential licensees have access. Due to such sensitivity, this verification step should occur as early as possible in the process.

Access control protocol will also allow for data to be aggregated across all PLC blockchains by a host. While most parties have access to the Licensing Blockchain 151, Books Blockchain 152 and SSO Blockchain data 153, such access is only for the specific blockchain for which PLC or technology that party has some participation. For example, a speculator must pay a subscription fee paid by technology category and then gains access to each decentralized blockchain. The only centralization of data across all blockchains and all technology categories is by a host so that an aggregated database may be established containing important licensing terms so that comparables data may be accumulated in a central database (to be used by appraisers under subscription).

### Web Page Format

A party will use a web page (URL) to access the blockchain 10 (FIG. 1) by clicking on a link, for example “Launch your PLC Blockchain.” A form is opened that allows the party to fill-in the parameters for the blockchain 10 and smart contract including: identify as patent owner or technology implementer, patent no(s), identified standard, essentiality determination and request upload of standard license agreement from patent owner and list of other potential licensees/technology implementers. The form is processed by software programmer/coder to establish a specific PLC blockchain 10.

The preceding specification identifies specific embodiments of the present invention, yet one of ordinary skill in the art would know that the scope of the invention is broader than just the preceding embodiments and that the scope of the invention of the present application should be determined by analysis of the claims of the patent application which are appended hereto.

What is claimed:

1. A system comprising:
a memory; a blockchain stored within the memory, the blockchain comprising a first block comprising a patent number and patent owner address; and a second block including a first licensee address and a standard contract including a license grant; and a payment module configured to generate proportional payments for a custodian identified in the blockchain by calculating the proportional payments based on rates provided in the second block, the proportional payments distributed among more than one custodian and the first and second block combined into the blockchain.

2. The system of claim 1 wherein the custodian controls or owns an asset contributed to the blockchain

3. The system of claim 2 wherein the asset comprises one of a comparable licensing data, valuation data, proposed royalty rate, Fair Reasonable and Non-Discriminatory (FRAND) rate, patent license grant, IP assignment, IP license, IP covenant not to sue.

4. The system of claim 3 wherein the blockchain provides evidence of the FRAND rate.

5. The system of claim 1 wherein the blockchain comprises a proportional payment and determination when a contract has been executed.

6. A method of securely storing data across a network in a multi-dimensional distributed database, said method comprising the steps of: generating a blockchain comprising linked data blocks, said blockchain being configured to propagate one or more branching blockchains, wherein any existing branching blockchain is configured to propagate one or more additional branching blockchains, wherein each of said branching blockchains has a fork block from which said one or more branching blockchains can grow in multiple directions thereby forming a multi-dimensional database slidechain, wherein said growth occurs by adding new data blocks awarded each time a participating node in the network propagates an acceptable block with corresponding block hash, said fork block comprising a customizable set of licensing protocols that define, for each block in said branching blockchain at least how block data is stored, how block validity is verified, how valid chain consensus is achieved, and criteria for generating a new block, wherein a copy of said slidechain is distributed to every node in the network, and said one or more new blocks are propagated when a node in the network provides a valid response to an payment algorithm; computing a proportional share of the root payment protocol; storing data as a fork block payload to be included as part of the fork block, wherein said fork block comprises a custodian address; computing a payment proportion and distributing the payment portion from a contract protocol.

7. The method of claim 6 further comprising the steps of: creating a slide chain rule set describing computer readable instructions for interpreting and/or parsing data stored in data blocks; and storing said slide chain rule set as said root block payload wherein supplemental patent license contracts are executable on the slide chain.

8. The method of claim 6 further comprising the steps of: creating a slide chain rule set describing computer readable instructions for interpreting and/or parsing data stored in data blocks; and storing said slide chain rule set as said fork block payload including supplemental licensees.

9. The method of claim 6 further comprising the steps of: creating a slide chain rule set describing computer readable instructions for verifying the validity of data blocks; and storing said slide chain rule set as said root block payload in order to distribute proportional payments to custodians including asset owners and valuators.

10. The method of claim 6 further comprising the steps of: creating a slide chain rule set describing computer readable instructions for verifying the validity of data blocks; and storing said slide chain rule set as said fork block payload including transparent rate data.

11. A computer system configured to communicate with a distributed blockchain computer system that includes multiple computing nodes, each computing node configured to store a copy, or a portion thereof, of a blockchain of the distributed blockchain computer system, the computer system comprising: a transceiver configured to receive a match message from another computer system that matches data transaction requests, the match message including match data for a match between a first data transaction request that is associated with a first identifier and a second data transaction request that is associated with a second identifier; a storage system configured to store a data structure for a plurality of accounts, each one of the plurality of accounts including at least a private key and a public key, the plurality of accounts including an intermediary account, where the first and second identifiers are associated, respectively, with first and second accounts of the plurality of accounts; a processing system that includes at least one hardware processor, the processing system configured to: in response to reception of the match message: (a) generate a first blockchain transaction that includes the match data for the match between the first data transaction request and the second data transaction request; (b) transmit the first blockchain transaction to the distributed blockchain computer system for storage into the blockchain; generate at least one further blockchain transaction that includes information for a first transaction from the first identifier to an intermediary identifier that is associated with the intermediary account and information for a second transaction from the intermediary identifier to the second identifier; generate a second blockchain transaction and include a programmatic structure into the second blockchain transaction that is configured to be executed by the distributed blockchain computer system, the programmatic structure including a condition that, upon satisfaction thereof, is configured to trigger the generation of a third blockchain transaction that is submitted to the blockchain, wherein the condition is payment of a portion of a payment to a custodian as a result of the conclusion the blockchain transactions; and transmit the at least one further blockchain transaction including payment data to the distributed blockchain computer system for storage into the blockchain.

12. The computer system of claim 11, wherein the custodian includes an asset owner and a valuator, wherein the custodian includes the information for the first transaction from the first identifier to the intermediary identifier and the valuator includes information for the second transaction from the intermediary identifier to the second identifier.

13. The computer system of claim 11, wherein the processing system is further configured to: sign, with a private key from a trusted oracle account, an event that is used to satisfy the condition of the programmatic structure.

14. The computer system of claim 13, wherein satisfaction of the condition occurs if and only if the event has been signed by the private key of the trusted oracle account allowing for viewing of confidential blockchain data including contract terms.

15. The computer system of claim 11, wherein the payment transaction is structured to be from an identifier associated with one of the plurality of accounts that is associated with the computer system that matches data transaction requests to an identifier of an account associated with the computer system.

16. The computer system of claim 11, wherein the blockchain includes a fork.

17. A method of executing a license contract on a blockchain comprising the steps of:
broadcasting a smart contract of a blockchain to potential licensees;
inserting names and addresses of the potential licensees into the blockchain;
soliciting a valuation from an appraiser;
finalizing license contract terms by potential licensee;
reviewing previous licensing terms on the blockchain by the potential licensee;
executing the license contract;
notifying custodians of payment amounts; and
distributing payments to custodians and patentee.

18. The method of claim 17 further comprising the steps of: creating a slide chain rule set describing computer readable instructions for interpreting and/or parsing data stored in data blocks; and storing said slide chain rule set as said fork block payload including supplemental licensees.

19. The method of claim 17 further comprising the steps of: creating a slide chain rule set describing computer readable instructions for verifying the validity of data blocks; and storing said slide chain rule set as said root block payload in order to distribute proportional payments to custodians including asset owners and valuators.

20. The method of claim 17 further comprising the steps of: creating a slide chain rule set describing computer readable instructions for verifying the validity of data blocks; and storing said slide chain rule set as said fork block payload including transparent rate data.
